(19) United States
(12) Patent Application Publication
(10) Pub. No.: US 2008/0025187 A1
(43) Pub. Date: Jan. 31, 2008

(54) Optical pickup apparatus, method of controlling the same, and information recording and reproducing apparatus

(75) Inventor: Takaaki Furuya, Higashihiroshima-shi (JP)

Correspondence Address: MORRISON & FOERSTER LLP, 1650 TYSONS BOULEVARD, SUITE 400, MCLEAN, VA, 22102, US

(73) Assignee: SHARP KABUSHIKI KAISHA, Osaka-shi (JP)

(21) Appl. No.: 11/878,919

(22) Filed: Jul. 27, 2007

(30) Foreign Application Priority Data
Jul. 31, 2006 (JP) 2006-209275

(51) Int. Cl. G11B 7/00

(52) U.S. Cl. 369/112.2

(57) ABSTRACT

An optical pickup apparatus in which a plurality of light sources emitting a plurality of light beams whose wavelengths are different from each other and degree of reliability of signals detected by a photodetector is high, a method of controlling the same, and an information recording and reproducing apparatus are provided. An objective lens, a λ/4 plate and a polarizing element whose outer edge portion is formed of a polarizer are formed integrally, which polarizing element is disposed so as to serve as an aperture stop with respect to a return light beam having a shorter wavelength.

### CROSS-REFERENCE TO RELATED APPLICATION

This application claims priority to Japanese Patent Application No. 2006-209275, which was filed on Jul. 31, 2006, the contents of which are incorporated herein by reference in their entirety.

### BACKGROUND OF THE INVENTION

1. Field of the Invention

The present invention relates to an optical pickup apparatus which carries out at least any one of recording, reproducing and deleting record information on a plurality of optical information recording mediums of different standards, a method of controlling the same, and an information recording and reproducing apparatus.

Hereinafter, a medium, on which at least any one of recording, reproducing and deleting signals is carried out by using a laser beam is called as a “recording medium”, and a light beam after being reflected on a recording surface of the recording medium is called as a “return light beam”. A “resin film” and a “dielectric multilayer film” mean a “film-like or plate-like member made of a resin” and a “multilayer film-like or plate-like member made of dielectrics”, respectively.

2. Description of the Related Art

As optical pickup apparatuses, which carry out recording, reproducing and deleting information to an optical information recording medium, a variety of systems have been suggested and used. In optical disks called as CD system such as compact disc (CD), compact disc-Recordable (CD-R) and compact disc-Rewritable (CD-RW), among optical information recording mediums, a laser light source emitting a light beam having an eoscillation wavelength of from 780 to 785 nm is used to perform recording, reproducing or deleting of signals. On the other hand, in optical disks called as DVD system such as Digital Versatile Disc (DVD), Digital Versatile Disc-Recordable (DVD-R) and Digital Versatile Disc-Rewritable (DVD-RW), a laser light source emitting a light beam having an oscillation wavelength of from 630 to 690 nm is used to perform recording, reproducing or deleting of signals.

Usable wavelengths and thicknesses of light transmitting substrates are different between the CD system and the DVD system. For these plural types of optical information recording mediums, it has been intended to attain an optical pickup apparatus for multiple wavelengths, capable of recording, reproducing and deleting signals on its own and a variety thereof have been suggested.

Taking a CD whose usable wavelength is 785 nm and a DVD whose usable wavelength is 650 nm, as examples of the plural types of the optical information recording mediums, a Numerical Aperture (NA) of an objective lens needs to be 0.5 in the CD and 0.6 to 0.65 in the DVD. One of problems caused when carrying out record, reproduction or deletion of signals of the plural types of the optical information recording mediums by the single apparatus is that average diameters of return light beams are different between a case in which a CD is used and another case in which a DVD is used, because the NAs are different from each other. The average diameter of a return light beam entering a photodetector is large in the DVD or small in the CD. The average diameter of the light beam in the case of the DVD is 1.2 to 1.3 times larger than that of the CD. In a case where the average diameter of the return light beam entering the photodetector is small, degree of reliability of the signal is relatively lowered with respect to deviation of an optical axis when the objective lens is moved in parallel with the recording surface of the recording medium, so that the degree of reliability in treating the CD is 1.2 to 1.3 times lowered than that in treating the DVD.

In order to receive the return light beams from the plural types of the optical information recording mediums whose usable wavelength are different from each other by the single photodetector having a common receiving portion region, and allow detection of signals by a same method as the optical pickup apparatus for the single wavelength, an art of using a partial hologram which changes its function according to the wavelengths is suggested (refer to Japanese Unexamined Patent Publication JP-A 2002-216385), in which a wavelength filter of a circular opening for restricting the light beams in a wavelength-selective manner is described. In a case of using a laser/detector integrated unit, in which the laser light source and the photodetector are integrated, in order to solve a problem that correct detection may not be carried out owing to flare light entering the photodetector, an art of disposing an aperture restriction portion is suggested (refer to Japanese Unexamined Patent Publication JP-A 11-344666 (1999)).

FIG. 10 is a view showing a state where the optical axis of the return light beam 2 after being transmitted by the objective lens is in line with that of the circular opening 3 of the wavelength filter and the return light beam enters the light receiving surface of the photodetector 1, according to a related art. FIG. 11 is a view showing a state where the return light beam 2 after being transmitted by the objective lens causes a deviation from the circular opening 3 of the wavelength filter when the objective lens is moved, independently from the wavelength filter, on a virtual plane in parallel with the recording surface of the optical information recording medium, according to a related art. When the objective lens is moved independently from the wavelength filter and the objective lens is shifted in a direction parallel with the recording surface of the optical information recording medium, a deviation between the cross section of the return light beam 2 and the circular opening 3 of the wavelength filter on the light receiving surface of the photodetector 1 is caused, so that the desired cross sectional shape of the light beam entering the photodetector cannot be obtained. Therefore, the degree of reliability of the signal detected by the photodetector is lowered. The aperture restriction portion is provided for the purpose of removing the flare, so that the average diameter of the return light beam is still dependent on the NA and is changed according to the usable wavelength.

### SUMMARY OF THE INVENTION

An object of the present invention is to provide an optical pickup apparatus provided with a plurality of light sources which emit a plurality of light beams different from each other, in which degree of reliability of signals detected by a photodetector is high, a control method thereof, and an information recording and reproducing apparatus.

The invention provides an optical pickup apparatus comprising: a plurality of light sources which emit a plurality of light beams whose wavelengths are different from each other; an objective lens which condenses the light beam emitted from each of the light sources on a recording surface of a recording medium; a polarizing element disposed on a way of an optical path between the light source and the objective lens, which transmits the light beam emitted from each of the light sources, an outer edge portion of the polarizing element being formed of a polarizer; and a photodetector which receives a return light beam reflected on the recording surface.

According to the invention, by providing the plurality of light sources, it is made possible to carry out recording, reproducing or deleting information to different types of information recording mediums by a single apparatus using a plurality of light beams whose wavelengths are different from each other. By forming the outer edge portion of the polarizing element by the polarizer, a linearly polarized light beam with a particular polarization direction can be shut off by the outer edge portion and polarized light beams with any polarization direction can be transmitted by a center portion that does not include the outer edge portion in the polarizing element. Therefore, the polarizing element can serve as an aperture stop with respect to a linearly polarized light beam with a particular polarization direction. By disposing the polarizing element on the way of the optical path between the light source and the objective lens, one of an outward light beam and a return light beam is entirely transmitted thereby such that the polarizing element serves as an aperture stop with respect to the other. Thereby, an optical pickup apparatus, in which a plurality of light sources emitting a plurality of light beams whose wavelengths are different from each other are provided and degree of reliability of signals detected by a photodetector is high can be realized.

In the invention, it is preferable that the polarizing element is disposed integrally with the objective lens.

According to the invention, by disposing the polarizing element integrally with the objective lens, even when the objective lens moves in parallel with the recording surface of the recording medium, a relative deviation between a position of the objective lens and a position of the polarizing element is not caused. A cross sectional area of a light beam is determined by a cross sectional area of the smallest aperture stop on the way of the optical path, and in the invention, determined by the objective lens, if the polarizing element is removed. Therefore, if a deviation between the objective lens and the aperture stop with respect to the return light beam is caused, the deviation is reflected on the cross section of the light beam entering the photodetector. Therefore, by disposing the polarizing element and the objective lens integrally and preventing the relative deviation between the polarizing element and the objective lens, the polarizing element can transmit the light beam without preventing the objective lens from condensing the outward light beam on the recording surface, or restricting the cross sectional area and the cross sectional shape of the return light beam by the relative deviation.

In the invention, it is preferable that the outer edge portion of the polarizing element serves as an aperture stop with respect to the return light beam having a shorter wavelength among the light beams whose wavelengths are different from each other.

According to the invention, the polarizing element has a function of an aperture stop with respect to the return light beam having the shorter wavelength, so that the cross sectional areas of the return light beams are equalized to each other with respect to the light beams whose wavelengths are different from each other. As to the outward light beam, if the aperture stop of the objective lens is not the smallest, NA of the objective lens is changed. Since the NA of the objective lens needs to meet the specification, the polarizing element must not act as an aperture stop with respect to the outward light beam. The polarizing element according to the invention acts as an aperture stop with respect to the return light beam, and never changes the NA of the objective lens so that the cross sectional areas of the light beams entering the photodetector are equalized to each other with respect to the light beams whose wavelengths are different from each other and the degrees of reliability of signals with respect to the deviation of the optical axis are equalized to each other. That is, the degree of reliability with respect to the return light beam having the longer wavelength can be equalized to the degree of reliability with respect to the return light beam having the shorter wavelength without changing the conventionally higher degree of reliability with respect to the return light beam having the shorter wavelength, than the degree of reliability with respect to the return light beam having the longer wavelength. Thereby, an optical pickup apparatus, which has a plurality of light sources emitting a plurality of light beams whose wavelengths are different from each other and high degree of reliability of signals detected by a photodetector can be realized.

In the invention, it is preferable that the optical pickup apparatus further comprises a λ/4 plate disposed on the way of the optical path between the objective lens and the polarizing element.

According to the invention, since the optical pickup apparatus comprises a λ/4 plate disposed on the way of the optical path, it is possible to cause a difference of 90° between the polarization direction of the polarized outward light beam and the polarization direction of the polarized return light beam so as to make the polarization directions cross at right angles with each other. Therefore, a difference can be caused in transmittance of the polarizer disposed on the way of the optical path of the outward light beam and the return light beam, with respect to the outward light beam and the return light beam. Thereby, the polarizing element, which is disposed on a position away from the objective lens across the λ/4 plate, can serve as an aperture stop with respect to only the return light beam.

In the invention, it is preferable that the polarizing element has a glass and a dielectric multilayer film.

According to the invention, the polarizing element can be formed by using a glass and a dielectric multilayer film. In a case where a part of the polarizing element is formed by using a glass as a material, the glass portion can be a member whose rigidity is higher than a member made of a resin or the like, so that the polarizing element whose mechanical and optical reliability is high is formed.

In the invention, it is preferable that the polarizing element has a resin film made of a resin material and a dielectric multilayer film.

According to the invention, the polarizing element can be formed by using a resin film made of the resin material and a dielectric multilayer film. In this case, cost of the material of the polarizing element can be lowered, and weight reduction of the polarizing element and the optical pickup apparatus can be achieved, compared to a case where the polarizing element is formed by using a glass material.

In the invention, it is preferable that the λ/4 plate is made of a crystal glass.

According to the invention, the λ/4 plate can be formed by using a crystal glass as a material thereof. In a case where the λ/4 plate is formed by using the crystal glass as the material, the rigidity of the λ/4 plate can be higher, compared to the case where the λ/4 plate is formed by using resin or the like as the material, so that the λ/4 plate whose mechanical and optical reliability is high is formed.

In the invention, it is preferable that the λ/4 plate is made of resin.

According to the invention, the λ/4 plate can be formed by using resin as a material thereof. In this case, costs of the material of the λ/4 plate can be reduced, and weight reduction of the λ/4 plate and the optical pickup apparatus can be achieved, compared to a case where the λ/4 plate is formed by using a crystal glass as the material.

In the invention, the optical pickup apparatus further comprises an image formation size adjusting section on an upstream side of the optical path of the photodetector so as to adjust a cross sectional area of the light beam entering the photodetector by changing a distance between the image formation size adjusting section and the photodetector.

According to the invention, the optical pickup apparatus comprises an image formation size adjusting section on the upstream side of the optical path of the photodetector so as to adjust a cross sectional area of the light beam entering the photodetector by changing a distance between the image formation size adjusting section and the photodetector, so that the cross sectional area of the light beam entering the photodetector is adjusted. Therefore, degrees of reliability of signals can be adjusted, and degrees of reliability of any of return light beams whose wavelengths are different from each other can be enhanced.

In the invention, it is preferable that the light sources and the photodetector are separately disposed.

According to the invention, since the light sources and the photodetector are separately disposed, the position of the photodetector can be changed so as to change the cross sectional area of the light beam entering the photodetector. The light sources and the photodetector can be separately exchanged. Therefore, a type, a number and specification of the light sources and the photodetector can be changed.

Furthermore, the invention provides an information recording and reproducing apparatus provided with the above-mentioned optical pickup apparatus.

According to the invention, an information recording and reproducing equipment, which has the optical pickup apparatus presenting the above effects, can be attained.

Furthermore, the invention provides a method of controlling a light beam in an optical pickup apparatus comprising: a light emission step of emitting a light beam from any one of a plurality of light sources capable of emitting the beams whose wavelengths are different from each other; a light condensation step of condensing the light beam emitted from the light source, on a recording surface of a recording medium by an objective lens; a light detection step of receiving and detecting a return light beam reflected on the recording surface of the recording medium by a photodetector; an aperture restriction step of restricting a cross sectional area of a return light beam having a longer wavelength among the light beams whose wavelengths are different from each other by a polarizing element whose outer edge portion is formed of a polarizer; and an image formation size adjustment step of adjusting a cross sectional area of the light beam entering the photodetector which receives and detects the return light beam in the light detection step, by changing a distance between the image formation size adjusting section and the photodetector.

According to the invention, the method includes an aperture restriction step of restricting the cross sectional area of the return light beam having the longer wavelength, so that the cross sectional areas of the return light beams whose wavelengths are different from each other are equalized to each other. Therefore, the cross sectional areas of the light beams entering the photodetector can be equalized to each other with respect to the light beams whose wavelength are different from each other, and the degrees of reliability of signals with respect to the deviation of the optical axis can be equalized to each other. Further, the image formation size adjustment step, in which the cross sectional area of the light beam entering the photodetector is adjusted by changing the distance between the image formation size adjusting section and the photodetector, is included so as to adjust the equalized degrees of reliability. That is, the degree of reliability with respect to the return light beam having the longer wavelength can be equalized to the degree of reliability with respect to the return light beam having the shorter wavelength without changing the conventionally higher degree of reliability with respect to the return light beam having the shorter wavelength, than the degree of reliability with respect to the return light beam having the longer wavelength. Thereby, an optical pickup apparatus, which has a plurality of light sources emitting a plurality of light beams whose wavelengths are different from each other and high degree of reliability of signals detected by a photodetector can be realized. In other words, an optical pickup apparatus, whose versatility is high with respect to the record mediums and whose degree of reliability is high, can be realized.

### BRIEF DESCRIPTION OF THE DRAWINGS

Other and further objects, features, and advantages of the invention will be more explicit from the following detailed description taken with reference to the drawings wherein:

FIG. 1 is a view showing a state that outward light beams from a first light source and a second light source are condensed onto a recording surface of a recording medium in an optical pickup apparatus according to an embodiment of the invention;

FIG. 2 is a top plan view of a polarizing element according to the embodiment of the invention;

FIG. 3 is a view showing a state where a light reflected on the recording surface of CD is detected by a photodetector in the optical pickup apparatus according to the embodiment of the invention;

FIG. 4 is a top plan view of a light receiving surface of the photodetector when a return light beam from the CD enters the light receiving surface of the photodetector in the embodiment of the invention;

FIG. 5 is a view showing a state where a light beam reflected on the recording surface of DVD is detected by the photodetector in the optical pickup apparatus according to the embodiment of the invention;

FIG. 6 is a view showing a state where a polarizing element, a λ/4 plate and an objective lens are moved integrally, in treating the CD as an example, in the embodiment of the invention;

FIG. 7 is a flow chart showing steps of a controlling method of an optical pickup apparatus according to the embodiment of the invention;

FIG. 8 is a flow chart showing a light condensation step more in detail according to the embodiment of the invention;

FIG. 9 is a flow chart showing a light detection step more in detail according to the embodiment of the invention;

FIG. 10 is a view showing a state where an optical axis of a return light beam after being transmitted by the objective lens is in line with circular opening of a wavelength filter and the return light beam is entered onto the photodetector, according to a related art; and

FIG. 11 is a view showing a state where the return light beam after being transmitted by the objective lens causes a deviation from the circular opening of the wavelength filter when the objective lens is moved, independently from the wavelength filter, on a virtual plane in parallel with a recording surface of the optical information recording medium, according to a related art.

### DETAILED DESCRIPTION

Now referring to the drawings, preferred embodiments of the invention are described below.

In the text of the specification, an optical information recording medium carrying out at least any one of record, reproduction and deletion of signals by using a laser light source emitting a laser beam whose oscillation wavelength is from 780 to 785 nm is called as “CD”, and an optical information recording medium carrying out record, reproduction or deletion of signals by using a laser light source emitting a laser beam whose oscillation wavelength is from 630 to 690 nm is called as “DVD”. A light beam after being emitted from the light source and before arriving at a recording surface of the recording medium may be called as an “outward light beam”, signals detected by a photodetector may be called simply as “signals”, and degree of reliability of signals with respect to a deviation of an optical axis may be called simply as “degree of reliability”.

Now referring to the drawings, preferred embodiments of the invention are described below. FIG. 1 is a view showing a state that outward light beams from a first light source 11 and a second light source 12 are condensed onto the recording surface of the recording medium in an optical pickup apparatus 10 according to the embodiment of the invention. The optical pickup apparatus 10 has the first light source 11, the second light source 12, a dichroic beam splitter 13, a polarization beam splitter 15, a collimation lens 16, a polarizing element 17, a λ/4 plate 18, the objective lens 19, an image formation size adjusting section 20 and a photodetector 21. The polarizing element 17, the λ/4 plate 18 and the objective lens 19 are formed integrally. The dichroic beam splitter 13 has a dichroic mirror 14.

The first light source 11 is a semiconductor laser light source, which emits a linearly polarized laser beam whose wavelength λ1 equals 785 nm. The second light source 12 is a semiconductor laser light source, which emits a linearly polarized laser beam whose wavelength λ2 equals 650 nm. The laser beam emitted from the first light source 11 or the second light source 12 enters the dichroic mirror 14 in the dichroic beam splitter 13. The dichroic mirror 14 transmits the light beam with the wavelength λ1 from the first light source 11 and reflects the light beam with the wavelength λ2 from the second light source 12. Although the first light source 11 and the second light source 12 are disposed on different positions from each other, the dichroic beam splitter 13 and the dichroic mirror 14 are disposed so as to make the laser beam with the wavelength λ1 from the first light source 11 and the laser beam with the wavelength λ2 from the second light source 12 travel in a same direction as each other. The laser beam exiting the dichroic beam splitter 13 enters the polarization beam splitter 15. The polarization beam splitter 15 transmits the linearly polarized outward light beams from the first light source 11 and the second light source 12 and reflects a linearly polarized light beam whose polarization plane is perpendicular to those of the beams from the first and second light sources. Therefore, the outward light beams are transmitted by the polarization beam splitter 15 and then enter the collimation lens 16. The collimation lens 16 collimates the outward light beams from the first light source 11 and the second light source 12, respectively. The laser beams collimated by the collimation lens 16 enter the polarizing element 17. The polarizing element 17 transmits the outward light beams emitted from the first light source 11 and the second light source 12 without changing polarization states and polarization directions. The laser beams subsequently enter the λ/4 plate 18. The λ/4 plate 18 adapted so as to convert the linearly polarized light beam emitted from the second light source 12 into a circularly polarized light. The laser beams transmitted by the λ/4 plate 18 enter the objective lens 19, and the laser beams are condensed onto the recording surface of the CD 25 or the DVD 26 by the objective lens 19. An area of the objective area 19, which is perpendicular to an optical axis thereof is smaller than a cross sectional areas of the outward light beams entering the objective lens 19, so that the amount of the laser beam condensed onto the CD 25 or the DVD 26 is determined by the area of the objective lens 19.

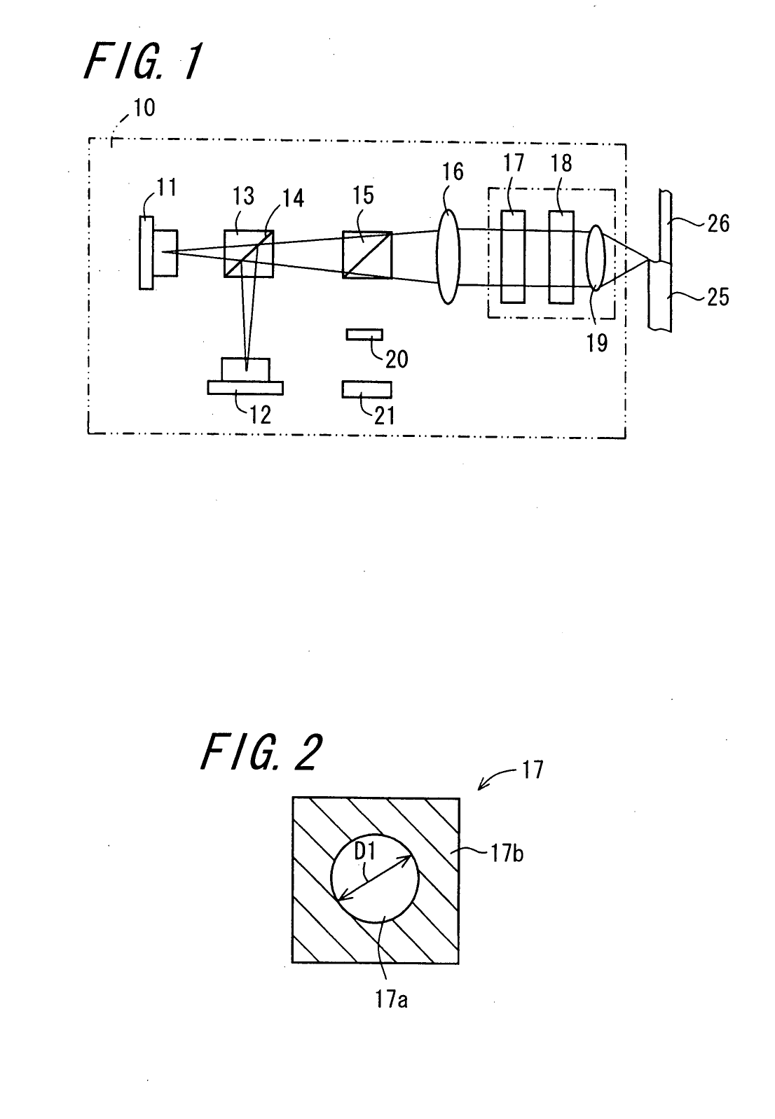

FIG. 2 is a top plan view of the polarizing element 17 according to the embodiment of the invention. The polarizing element 17 is plate-shaped. The polarizing element 17, in plan view seen in a thickness direction thereof, is rectangular-shaped, and has a non-active area 17a composed of a resin filter or a glass material in a center portion thereof. The non-active area 17a transmits the laser beam with the wavelength λ1 as well as the laser beam with the wavelength λ2, regardless of the polarization states of the laser beams. The non-active area 17a has the same area and shape as the cross sectional area and the cross sectional shape of the return light beam from the CD 25, respectively. In plan view seeing the polarizing element 17 in the thickness direction thereof, a shape of the non-active area 17a is circular, in the embodiment, and a diameter D1 thereof is smaller than a cross sectional diameter of the return light beam with the wavelength λ2 and is the same as a cross sectional diameter of the return light beam with the wavelength λ1. An outer edge portion that does not include the non-active area 17a in the polarizing element 17 is a polarizing area 17b formed of a dielectric multilayer film. The polarizing area 17b is composed of a polarizer, and transmits a linearly polarized light beam with a specific polarization direction and shuts off a linearly polarized light whose polarization direction is perpendicular to that of said linearly polarized light. The polarizing element 17 is disposed such that the linearly polarized outward light beams emitted from the first light source 11 and the second light source 12 are transmitted by the polarizing area 17b. The cross sectional areas of the light beams are determined by a cross sectional area of the smallest aperture stop on a way of an optical path, and in the embodiment, determined by the objective lens if the polarizing element 17 is removed. As to the outward light beams, the NA of the objective lens is changed if the aperture stop of the objective lens is not the smallest. Since the NA of the objective lens needs to meet the specification, the polarizing element must not act as an aperture stop with respect to the outward light beams.

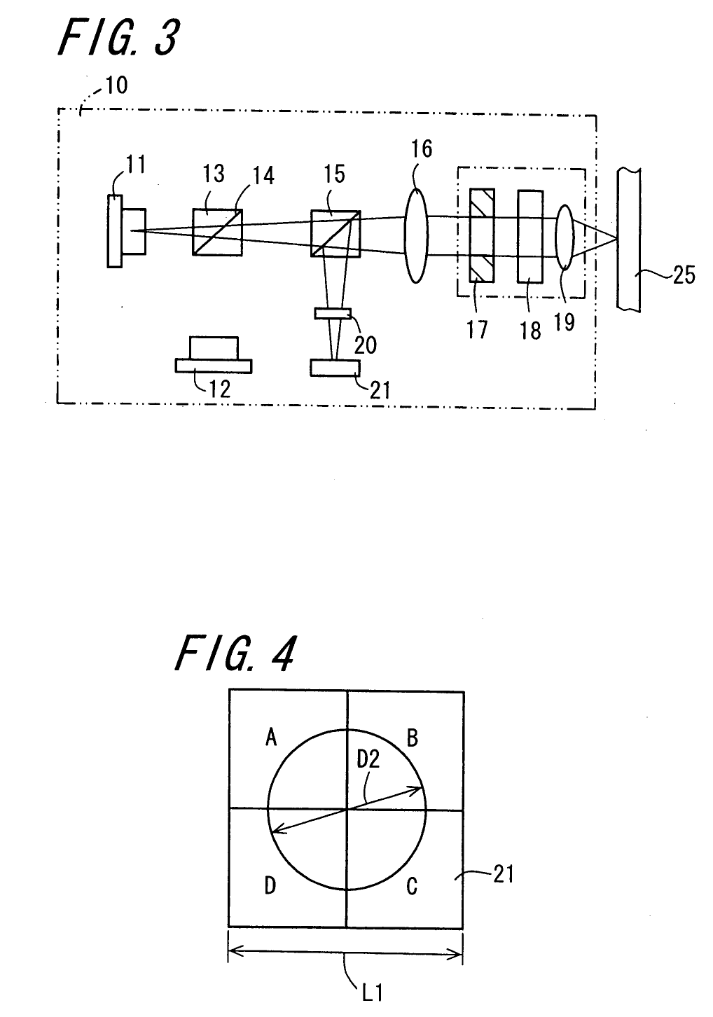

FIG. 3 is a view showing a state where the light beam reflected on the recording surface of the CD 25 is detected by the photodetector 21 in the optical pickup apparatus 10 according to the embodiment of the invention. In treating the CD 25, the laser beam is emitted from the first light source 11. The NA of the objective lens with respect to the laser beam with the wavelength λ1 is 0.5, and the cross sectional area of the return light beam shortly after being transmitted by the objective lens 19 is smaller than that in treating DVD 26. The laser beam reflected on the recording surface of the CD 25 is transmitted by the objective lens 19, subsequently transmitted by the λ/4 plate 18 and the polarizing element 17. The cross sectional area and the cross sectional shape of the return light beam from the CD 25 correspond with those of the non-active area 17a of the polarizing element 17, so that the return light beam from the CD 25 is entirely transmitted by the polarizing element 17. The return light beam is subsequently transmitted by the collimation lens 16 and enters the polarization beam splitter 15. The polarization direction of the polarized return light beam from the CD 25 is different from the polarization direction of the linearly polarized outward light beam from the first light source 11, so that the return light beam from the CD 25 is reflected by the polarization beam splitter 15 and then enters the image formation size adjusting section 20. The image formation size adjusting section 20 is an optical member, which adjusts the cross sectional area of the light beam entering the photodetector 21 by changing a distance between the image formation size adjusting section 20 and the photodetector 21. The return light beam from the CD 25 transmitted by the image formation size adjusting section 20 enters the photodetector 21 and is detected by the photodetector 21.

FIG. 4 is a top plan view of a light receiving surface of the photodetector 21 when the return light beam from the CD 25 enters the light receiving surface of the photodetector 21 in the embodiment of the invention. The light receiving surface of the photodetector 21 is square-shaped and has four-divided light receiving regions A to D. As shown in FIG. 4, the light receiving regions A to D are square-shaped, respectively, and the light receiving region A and the light receiving region C are arranged on a diagonal line and the light receiving region B and the light receiving region D are arranged on the other diagonal line. The photodetector 21 receives the return light beam from the CD 25 or the DVD 26 and outputs a focus error signal, a tracking error signal and a radio frequency (RF) signal. When a tracking error is caused, a difference between outputted signals from the light receiving region A and the light receiving region D is caused, and a difference between outputted signals from the light receiving region B and the light receiving region C is caused. When the outputted signals from the light receiving regions A to D are described as SA, SB, SC and SD, respectively, the focus error signal, the tracking error signal and the RF signal are outputted by calculations of expressions (1) to (3), respectively.

Focus error signal:(SA+SC)−(SB+SD) (1)

Tracking error signal:(SA+SB)−(SC+SD) (2)

RF signal:(SA+SB+SC+SD) (3)

A cross sectional shape of the return light beam from the CD 25 entering the light receiving surface of the photodetector 21 is circular. The cross sectional area of the cross section of the light beam is adjusted by the image formation size adjusting section 20; a diameter D2 of a circle of the cross section is adjusted so as to be from 60% to 70% with respect to a length L1 of a side of the light receiving surface.

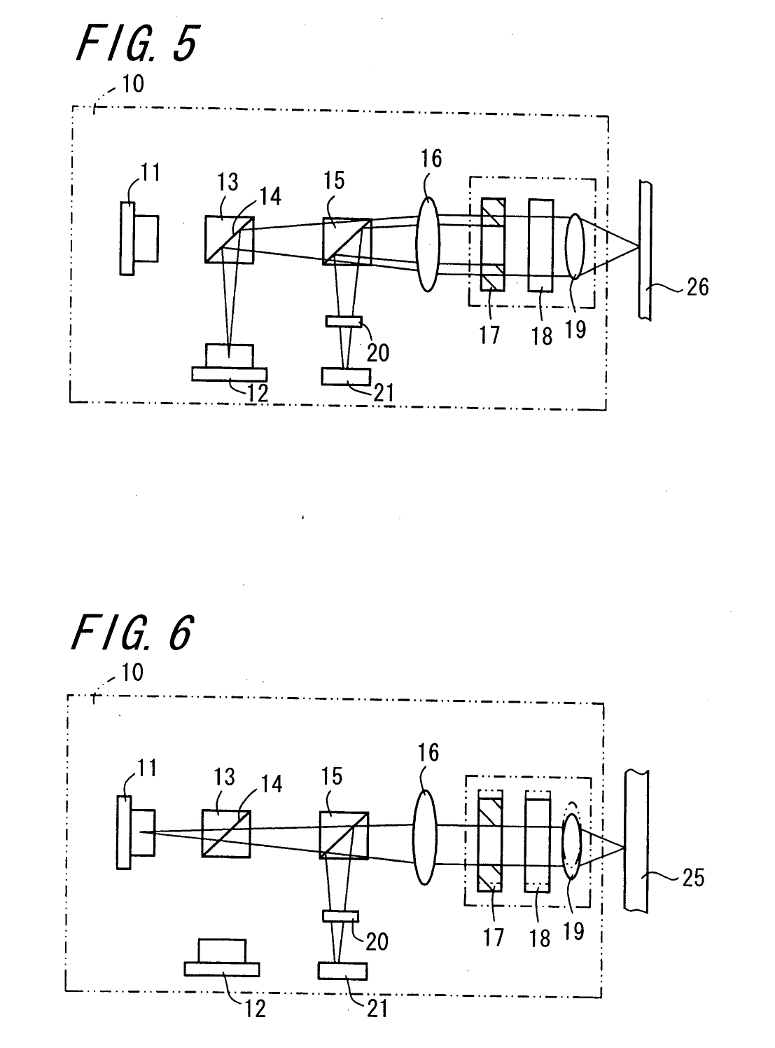

FIG. 5 is a view showing a state where the light reflected on the recording surface of the DVD 26 is detected by the photodetector 21 in the optical pickup apparatus 10 according to the embodiment of the invention. In treating the DVD 26, the second light source 12 emits the laser beam. The NA of the objective lens 19 with respect to the laser beam with the wavelength λ2 is from 0.6 to 0.65, and the cross sectional area of the return light beam shortly after being transmitted by the objective lens 19 is larger than that in treating the CD. The outward light beam emitted to the DVD 26 has been converted to a circularly polarized light by the λ/4 plate 18, and the laser beam reflected on the recording surface of the DVD 26 is transmitted by the objective lens 19 and reenters the λ/4 plate 18. The circularly polarized return light beam after being reflected on the recording surface of the DVD 26 is converted to a linearly polarized light by the λ/4 plate 18. The polarization direction of the linearly polarized return light beam has an angular difference of 90° with respect to the polarization direction of the linearly polarized outward light beam.

The return light beam subsequently enters the polarizing element 17. The cross sectional shape of the return light beam from the DVD 26 immediately before entering the polarizing element 17 is circular, and the cross section is larger than the non-active area 17a of the polarizing element 17. A part of the return light beam having been made linearly polarized light by the λ/4 plate 18 is shut off by the polarizing area 17b of the polarizing element 17. Therefore, the polarizing element 17 act as an aperture stop with respect to the return light beam from the DVD 26, thereby the cross sectional area and the cross sectional shape of the return light beam from the DVD 26 is equalized to the non-active area 17a. In the return light beam from the DVD 26, whose part is shut off by the polarizing area 17b and which is transmitted by the non-active area 17a, the cross sectional area and the cross sectional shape of the return light beam are the same as the cross sectional area and the cross sectional shape of the return light beam from the recording surface of the CD 25, respectively. The return light beam is subsequently transmitted by the collimation lens 16 and enters the polarization beam splitter 15. The polarization direction of the polarized return light beam from the DVD 26 is different by 90° with respect to the polarization direction of the linearly polarized outward light beam from the first light source 11, so that the return light beam from the DVD 26 is reflected by the polarization beam splitter 15 and then enters the image formation size adjusting section 20. The return light beam from the DVD 26 transmitted by the image formation size adjusting section 20 enters the photodetector 21 and is detected by the photodetector 21.

The cross sectional area and the cross sectional shape of the return light beam from the DVD 26 entering the image formation size adjusting section 20 are the same as those of the return light beam from the CD 25 entering the image formation size adjusting section 20. Therefore, relative positional relationships between the image formation size adjusting section 20 and the photodetector 21 are the same in treatments of the CD 25 and the DVD 26 as each other. The diameter of the cross sectional circle of the return light beam from the DVD 26 is from 60% to 70% with respect to a side length of the square light receiving surface of the photodetector 21.

FIG. 6 is a view showing a state where the polarizing element 17, the λ/4 plate 18 and the objective lens 19 are moved integrally, in treating the CD 25 as an example, in the embodiment of the invention. The objective lens 19 can be displaced with respect to the recording surface of the CD 25 or the DVD 26 in order to carry out adjustments of focusing and tracking with respect to the CD 25 and the DVD 26. The polarizing element 17, the λ/4 plate 18 and the objective lens 19 are formed integrally in the embodiment of the invention so that, when the objective lens 19 is displaced with respect to the recording surface of the CD 25 or the DVD 26, the polarizing element 17 and the λ/4 plate 18 are displaced at the same time in the same amount and the same direction as the objective lens 19. The λ/4 plate 18 has a function of rotating the polarization direction of the polarized return light beam entering the polarizing element 17 by 90° from the polarization direction of the polarized outward light beam. Therefore, by disposing the λ/4 plate 18 on a downstream side of the optical path of the outward light beam and on an upstream side of the optical path of the return light beam with respect to the polarizing element 17, the polarizing element 17 can realize a selective action with respect to the polarization direction of the polarized light beam. That is, the polarizing element 17, which is disposed at a position away from the objective lens 19 across the λ/4 plate 18, serves as an aperture stop with respect to only the return light beam.

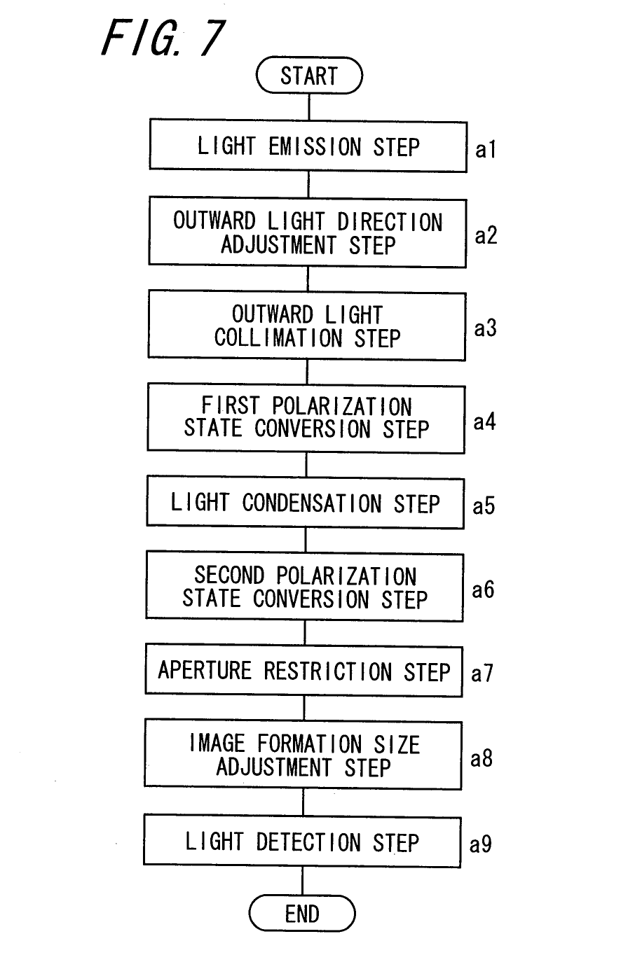

FIG. 7 is a flow chart showing steps of a controlling method of an optical pickup apparatus according to the embodiment of the invention. The controlling method of the optical pickup apparatus in the embodiment includes a light emission step a1, an outward light direction adjustment step a2, an outward light collimation step a3, a first polarization state conversion step a4, a light condensation step a5, a second polarization state conversion step a6, an aperture restriction step a7, an image formation size adjustment step a8 and a light detection step a9. After starting, the process is shifted to the light emission step a1, in which the light beam emission from the first light source 11 and the light beam emission from the second light source 12, which light sources 11 and 12 emit the light beams whose wavelengths are different from each other, are carried out independently. That is, light emission from any one of the first light source 11 and the second light source 12 is carried out at a time. Next, the process is shifted to the outward light direction adjustment step a2, in which both laser beams from the first light source 11 and the second light source 12 are directed to the recording surface of the recording medium by the dichroic mirror 14 in the dichroic beam splitter 13. Next, the process is shifted to the outward light collimation step a3, in which the laser beams from the first light source 11 and the second light source 12 are collimated by the collimation lens 16. Next, the process is shifted to the first polarization state conversion step a4, in which the polarization state of the laser beams from the first light source 11 and the second light source 12 are converted by the λ/4 plate 18. Next, the process is shifted to the light condensation step a5, in which the outward light beams after being transmitted by the λ/4 plate 18 are condensed on the recording surfaces of the recording mediums. Next, the process is shifted to the second polarization state conversion step a6, in which the polarization states of the laser beams reflected on the recording surfaces of the recording mediums are converted by the λ/4 plate 18. Next, the process is shifted to the aperture restriction step a7, in which the cross section of the return light beam having a longer wavelength among the different wavelengths is not restricted, and the cross sectional area and the cross sectional shape of the return light beam having a shorter wavelength among the different wavelengths is restricted, so as to be equalized to the cross sectional area and the cross sectional shape of the return light beam having the longer wavelength. Next, the process is shifted to the image formation size adjustment step a8, in which the return light beams from the recording surfaces of the recording mediums are adjusted such that the average diameter of the cross section of the light beams are from 60% to 70% with respect to the side length of the square light receiving surface of the photodetector 21. Next, the process is shifted to the light detection step a9, in which the return light beam is received by the photodetector 21 so as to detect signals. After that, the process is finished.

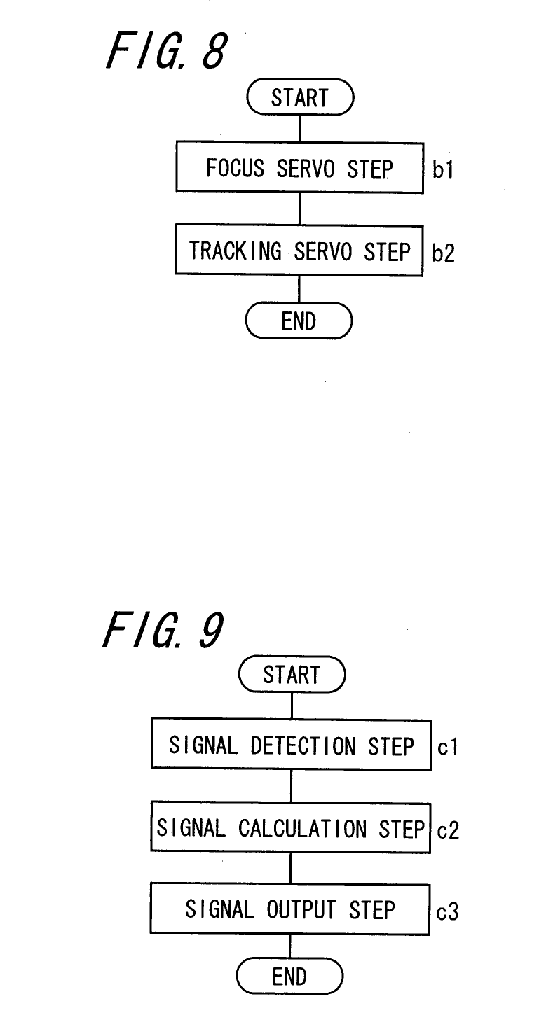

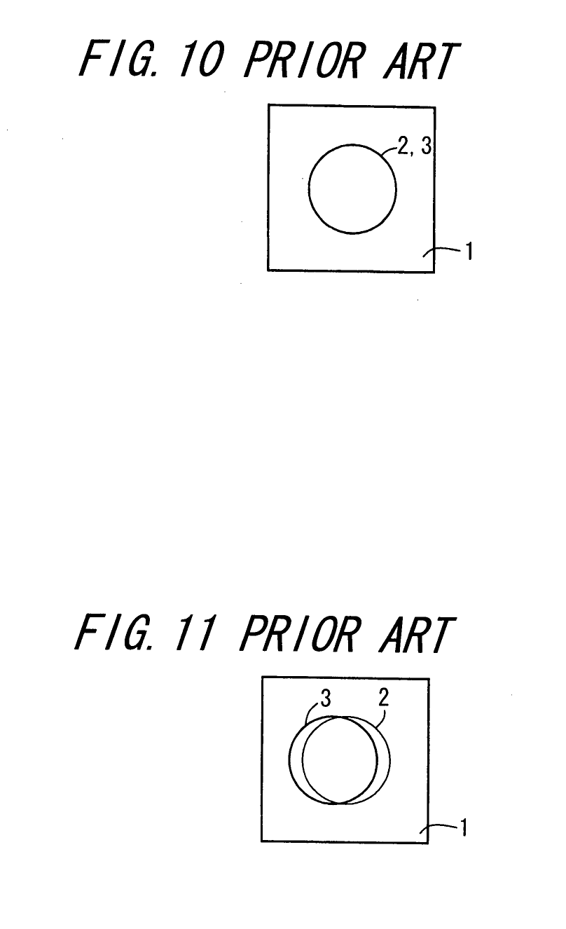

FIG. 8 is a flow chart showing the light condensation step a5 according to the embodiment of the invention more in detail. The light condensation step a5 includes a focus servo step b1 and a tracking servo step b2. After starting the process of the light condensation step a5, in the focus servo step b1, a position of the polarizing element 17, the λ/4 plate 18 and the objective lens 19 formed integrally is moved in a vertical direction to the recording surface of the recording medium such that a focus of the laser beam condensed by the objective lens is on the recording surface of the recording medium. Next, in the tracking servo step b2, the position of the polarizing element 17, the λ/4 plate 18 and the objective lens 19 formed integrally is moved on a virtual plane in parallel with the recording surface of the recording medium such that the focus of the laser beam condensed by the objective lens 19 is on a track on the recording surface of the recording medium. After that, this process is finished. The focus servo step b1 and the tracking servo step b2 may be carried out in a reverse order, or at the same time.

FIG. 9 is a flow chart showing the light detection step a9 according to the embodiment of the invention more in detail. The light detection step a9 includes a signal detection step c1, a signal calculation step c2 and a signal output step c3. After starting the process of the step of light detection, the process is sifted to the signal detection step c1, in which the return light beam from the recording surface of the recording medium is received by the four light receiving regions on the light receiving surface of the photodetector 21 so as to detect signals. Next, the process is sifted to the signal calculation step c2, in which the calculations of the expressions (1) to (3) are carried out based on the signals detected by the four light receiving regions. Next, the process is sifted to the signal output step c3, in which the focus error signal, the tracking error signal and the RF signal are outputted as a result of the calculations of the expressions (1) to (3). After that, this process is finished. The three signals of the focus error signal, the tracking error signal and the RF signal are utilized by a mechanism not illustrated.

Although the light source emitting the laser beam whose wavelength λ1 equals 785 nm is used as the first light source 11 in treating the CD 25 in the embodiment, a wavelength λ3 of the light emitted from the first light source is from 780 nm to 785 nm in another embodiment. The dichroic mirror in the dichroic beam splitter transmits the laser beam with the wavelength λ3.

Although the light source emitting the laser beam whose wavelength λ2 equals 650 nm is used as the second light source 12 in treating the DVD 26 in the embodiment, a wavelength λ4 of the light emitted from the second light source is from 630 nm to 690 nm in another embodiment. The dichroic mirror in the dichroic beam splitter reflects the laser beam with the wavelength λ4. The λ/4 plate converts the linearly polarized outward light beam with the wavelength λ4 to a circularly polarized light beam, and converts the circularly polarized return light beam with the wavelength λ4 to a linearly polarized light beam.

Although the cross sectional shapes of the laser beam with the wavelength λ1 and the laser beam with wavelength λ2 entering the polarizing element 17 are circular in the embodiment, the cross sectional shapes thereof can also be elliptic in another embodiment. The cross section of the return light beam from the recording surface of the DVD includes the cross section of the return light beam from the recording surface of the CD in the other embodiment. The area and the shape of the non-active area, which compose a part of the polarizing element, are the same as the cross sectional area and the cross sectional shape of the return light beam from the recording surface of the CD, respectively.

Although the λ/4 plate 18 converts the linearly polarized light to the circularly polarized light and the circularly polarized light to the linearly polarized light with respect to the laser beam whose wavelength λ2 equals 650 nm which is used in treating the DVD 26 in the embodiment, the λ/4 plate converts the linearly polarized light to the circularly polarized light and the circularly polarized light to the linearly polarized light with respect to the both laser beams whose wavelengths are used in treating the DVD and the CD in the other embodiment. By using λ/4 plates composed of a plurality of λ/4 plates bonded together, each of which serves in a wavelength-selective manner, the polarization direction of the linearly polarized outward light beam and the polarization direction of the linearly polarized return light beam are made different by 90°, and the polarization direction of the return light beam entering the polarizing element 17 is rotated by 90° from the polarization direction of the polarized outward light beam, with respect to both the laser beams whose wavelengths are usable in treating the DVD and the CD.

Although two of the first light source 11 and the second light source 12 are disposed as the light source in the embodiment, a plurality of light sources, other than two, may be used in another embodiment. The cross section of the return light beam having the shortest wavelength includes the cross sections of the return light beams with other wavelengths in the other embodiment. The area and the shape of the non-active area, which compose a part of the polarizing element, are the same as the cross sectional area and the cross sectional shape of the return light beam having the longest wavelength, respectively.

Although the light receiving surface of the photodetector 21 is square-shaped in this embodiment, the light receiving surface may not always be square-shaped in so far as the light receiving surface can receive the light beam after being transmitted by the image formation size adjusting section. Any shape and any size of the light receiving surface of the photodetector can be used in so far as the light beam does not run off the light receiving surface even when the optical axis of the light beam entering the light receiving surface is displaced within a range from 20% to 33% of the diameter or a semimajor axis of the light beam.

The optical pickup apparatus 10 according to the invention has the plurality of light sources and the polarizing element 17 whose outer edge portion is formed of the polarizer. By adopting such constitution, a plurality of light beams whose wavelength are different from each other can be used so as to carry out record, reproduce or delete with respect to different types of the information recording mediums by a single apparatus. By forming the outer edge portion of the polarizing element 17 of the polarizer, the linearly polarized outward light beam can be transmitted and the linearly polarized return light beam whose polarization direction is different by 90° from that of the linearly polarized outward light beam can be shut off. The center portion that does not include the outer edge portion in the polarizing element 17 transmits polarized light beams with any polarization direction. Therefore, the polarizing element 17 does not act on the outward light beam, but can selectively serve as an aperture stop with respect to the return light beam. Thereby, an optical pickup apparatus, in which a plurality of light sources emitting a plurality of light beams whose wavelengths are different from each other are provided and degree of reliability of signals detected by a photodetector is high can be realized.

By disposing the polarizing element 17, the λ/4 plate 18 and the objective lens 19 integrally, when the objective lens 19 is displaced with respect to the recording surface of the CD 25 or the DVD 26, the polarizing element 17 and the λ/4 plate 18 are displaced at the same time in the same amount and the same direction as the objective lens 19. Therefore, a relative deviation between the position of the objective lens 19 and the position of the polarizing element 17 is never caused. The cross sectional area of the light beam is determined by the cross sectional area of the smallest aperture stop on the way of the optical path, and in the invention, determined by the objective lens 19 if the polarizing element 17 is removed. Therefore, when the deviation between the objective lens 19 and the polarizing element 17, which is the aperture stop with respect to the return light beam, is caused, the deviation is reflected on the cross section of the light beam entering the photodetector 21. By disposing the polarizing element 17 and the objective lens 19 integrally and preventing the relative deviation between the polarizing element 17 and the objective lens 19, the polarizing element 17 can transmit the light beam without preventing the objective lens 19 from condensing the outward light beam on the recording surface of the CD 25 or the DVD 26, and without restricting the cross sectional area and the cross sectional shape of the return light beam by the relative deviation.

The polarizing element 17 has function as an aperture stop with respect to the return light beam having the shorter wavelength. Therefore, the cross sectional areas of the return light beams can be equalized to each other with respect to the light beams whose wavelengths are different from each other. As to the outward light beam, in a case where the aperture stop of the objective lens 19 is not the smallest, the NA of the objective lens is changed. The NA of the objective lens 19 needs to meet the specification, the polarizing element 17 must not act as an aperture stop with respect to the outward light beam. The polarizing element 17 according to the invention acts as an aperture stop with respect to the return light beam, and never changes the NA of the objective lens 19 so that the cross sectional areas of the light beams entering the photodetector 21 are equalized to each other with respect to the lights whose wavelengths are different from each other and the degree of reliability of the signals are equalized to each other. That is, the degree of reliability with respect to the return light beam having the longer wavelength can be equalized to the degree of reliability with respect to the return light beam having the shorter wavelength without changing the conventionally higher degree of reliability with respect to the return light beam having the shorter wavelength, than the degree of reliability with respect to the return light beam having the longer wavelength. Thereby, an optical pickup apparatus 10, which has a plurality of light sources emitting a plurality of light beams whose wavelengths are different from each other and degree of reliability of signals detected by a photodetector 21 is high can be realized.

The λ/4 plate 18 has a function of rotating the polarization direction of the polarized return light beam entering the polarizing element 17 by 90° from the polarization direction of the polarized outward light beam. Therefore, by disposing the λ/4 plate 18 on a downstream side of the optical path of the outward light beam and on an upstream side of the optical path of the return light beam with respect to the polarizing element 17, the polarizing element 17 can realize a selective action with respect to the polarization direction of the polarized light beam. That is, the polarizing element 17, which is disposed on a position away from the objective lens 19 across the λ/4 plate 18, can serve as an aperture stop with respect to only the return light beam.

In the embodiment, the λ/4 plate 18 converts the linearly polarized light to the circularly polarized light and the circularly polarized light to the linearly polarized light with respect to the laser beam whose wavelength λ2 equals 650 nm which is used in treating the DVD 26, however, in another embodiment, the λ/4 plate converts the linearly polarized light to the circularly polarized light and the circularly polarized light to the linearly polarized light with respect to both laser beams whose wavelengths are usable in treating the DVD and the CD. By using the λ/4 plates composed of a plurality of ¼ wavelength plates bonded together, each of which serves in a wavelength-selective manner, the polarization direction of the linearly polarized outward light beam and the polarization direction of the linearly polarized return light beam can be different by 90°, and the polarization direction of the polarized return light beam entering the polarizing element 17 can be rotated by 90° from the polarization direction of the polarized outward light beam, with respect to both the laser beams whose wavelengths are usable in treating the DVD and the CD. Thereby, the return light beam of the laser beam whose wavelength is usable in treating the CD is prevented from being an elliptically polarized light after being transmitted by the λ/4 plate, so that an amount of the return light beam after being reflected by the polarization beam splitter 15 is prevented from being less than the amount of the return light beam entering the polarization beam splitter 15. Therefore, an optical pickup apparatus, in which degree of reliability of signals detected by a photodetector is high in treating both the DVD and the CD can be realized. When the λ/4 plate is positioned on the downstream side of the optical path of the outward light beam and on the upstream side of the optical path of the return light beam with respect to the polarizing element 17, the polarizing element 17 can serve as an aperture stop with respect to only the return light beam.

The polarizing element 17 can be formed by using a glass material and a dielectric multilayer film. In a case where the non-active area 17a of the polarizing element 17 is formed by using a glass as a material, the non-active area 17a made of the glass can be a member whose rigidity is higher than a member made of a resin or the like, so that the polarizing element 17 whose mechanical and optical reliability is high is formed.

According to another embodiment, the polarizing element 17 can be formed by using a resin film made of a resin material and the dielectric multilayer film. In this case, cost of the material of the polarizing element 17 can be lowered, and the weight reduction of the polarizing element 17 and the optical pickup apparatus 10 can be achieved, compared to case where the polarizing element 17 is formed by using the glass.

The λ/4 plate 18 can be formed by using a crystal glass as a material thereof. In a case where the λ/4 plate 18 is formed by using a crystal glass as the material, the rigidity of the λ/4 plate can be higher, compared to case where the λ/4 plate is formed by using resin or the like as the material, so that the λ/4 plate 18 whose mechanical and optical reliability is high is formed.

According to another embodiment, the λ/4 plate 18 can be formed by using resin as the material. In this case, cost of the material of the λ/4 plate 18 can be lowered, and the weight reduction of the λ/4 plate 18 and the optical pickup apparatus 10 can be achieved, compared to case where the λ/4 plate 18 is formed by using a crystal glass as the material.

In the embodiment, the image formation size adjusting section 20 is disposed, on an upstream side of the optical path of the photodetector 21, so as to adjust the cross sectional area of the light beam entering the photodetector 21 by changing the distance between the image formation size adjusting section 20 and the photodetector 21. Therefore, the cross sectional area of the light beam entering the photodetector 21 can be adjusted. Therefore, with respect to any of the return light beams whose wavelengths are different from each other, the degree of reliability can be enhanced.

In the embodiment, the aperture restriction step of restricting the cross sectional area of the return light beam having the longer wavelength is included, so that the cross sectional areas of the return light beams whose wavelengths are different from each other are equalized to each other. Therefore, the cross sectional areas of the light beams entering the photodetector can be equalized to each other with respect to the light beams whose wavelength are different from each other, and the degree of reliability of signals with respect to the deviation of the optical axis can be equalized to each other. Further, since the image formation size adjustment step, in which the cross sectional area of the light beam entering the photodetector 21 is adjusted by changing the distance between the image formation size adjusting section 20 and the photodetector 21, is included, it is possible to adjust the equalized degrees of reliability. That is, an average diameter of the light beam entering the light receiving surface of the photodetector 21 is adjusted to be from 60% to 70% with respect to the side length of the light receiving surface by the image formation size adjusting section 20, thereby the degree of reliability with respect to the return light beam having the longer wavelength can be equalized to the degree of reliability with respect to the return light beam having the shorter wavelength without changing the conventionally higher degree of reliability with respect to the return light beam having the shorter wavelength, than the degree of reliability with respect to the return light beam having the longer wavelength. Thereby, an optical pickup apparatus, which has a plurality of light sources emitting a plurality of light beams whose wavelengths are different from each other and degree of reliability of signals detected by a photodetector 21 is high can be realized. In other words, an optical pickup apparatus, in whose versatility is high with respect to the record mediums and the degree of reliability is high can be realized.

In the embodiment, the photodetector 21 is disposed separately from the first light source 11 and the second light source 12, so that the position of the photodetector 21 can be changed so as to change the cross sectional area of the light beam entering the photodetector 21. The first light source 11, the second light source 12 and the photodetector 21 can be exchanged individually. Therefore, a type, a number and specification of the first light source 11, the second light source 12 and the photodetector 21 can be changed.

Further, according to the invention, an information recording and reproducing equipment which has the optical pickup apparatus exerting the above effects can be realized.

The present invention may be embodied in other specific forms without departing from the spirit or essential characteristics thereof. The embodiments are therefore to be considered as illustrative and not restrictive in all respects, the scope of the invention being indicated by the appended claims rather than by the foregoing description. Moreover, all changes which come within the meaning and the range of equivalency of the claims are therefore intended to be embraced therein.

What is claimed is:

1. An optical pickup apparatus comprising:
a plurality of light sources which emit a plurality of light beams whose wavelengths are different from each other;
an objective lens which condenses the light beam emitted from each of the light sources on a recording surface of a recording medium;
a polarizing element disposed on a way of an optical path between the light source and the objective lens, which transmits the light beam emitted from each of the light sources, an outer edge portion of the polarizing element being formed of a polarizer; and
a photodetector which receives a return light beam reflected on the recording surface.

2. The optical pickup apparatus of claim 1, wherein the polarizing element is disposed integrally with the objective lens.

3. The optical pickup apparatus of claim 1, wherein the outer edge portion of the polarizing element serves as an aperture stop with respect to the return light beam having a shorter wavelength among the light beams whose wavelengths are different from each other.

4. The optical pickup apparatus of claim 1, further comprising a λ/4 plate disposed on the way of the optical path between the objective lens and the polarizing element.

5. The optical pickup apparatus of claim 1, wherein the polarizing element has a glass and a dielectric multilayer film.

6. The optical pickup apparatus of claim 1, wherein the polarizing element has a resin film made of a resin material and a dielectric multilayer film.

7. The optical pickup apparatus of claim 4, wherein the λ/4 plate is made of a crystal glass.

8. The optical pickup apparatus of claim 4, wherein the λ/4 plate is made of resin.

9. The optical pickup apparatus of claim 1, further comprising an image formation size adjusting section on an upstream side of the optical path of the photodetector so as to adjust a cross sectional area of the light beam entering the photodetector by changing a distance between the image formation size adjusting section and the photodetector.

10. The optical pickup apparatus of claim 1, wherein the light sources and the photodetector are separately disposed.

11. An information recording and reproducing apparatus provided with the optical pickup apparatus of claim 1.

12. A method of controlling a light beam in an optical pickup apparatus comprising:
a light emission step of emitting a light beam from any one of a plurality of light sources capable of emitting the beams whose wavelengths are different from each other;
a light condensation step of condensing the light beam emitted from the light source, on a recording surface of a recording medium by an objective lens;
a light detection step of receiving and detecting a return light beam reflected on the recording surface of the recording medium by a photodetector;
an aperture restriction step of restricting a cross sectional area of a return light beam having a longer wavelength among the light beams whose wavelengths are different from each other by a polarizing element whose outer edge portion is formed of a polarizer; and
an image formation size adjustment step of adjusting a cross sectional area of the light beam entering the photodetector which receives and detects the return light beam in the light detection step, by changing a distance between the image formation size adjusting section and the photodetector.
